(19) United States
(12) Patent Application Publication
(10) Pub. No.: US 2019/0148966 A1
(43) Pub. Date: May 16, 2019

(54) WIRELESS POWER TRANSMITTER

(71) Applicant: Samsung Electro-Mechanics Co., Ltd., Suwon-si (KR)

(72) Inventors: Jung Woo CHOI, Suwon-si (KR); Tae Seok KO, Suwon-si (KR); Byoung Woo RYU, Suwon-si (KR)

(73) Assignee: Samsung Electro-Mechanics Co., Ltd., Suwon-si (KR)

(21) Appl. No.: 16/018,674

(22) Filed: Jun. 26, 2018

(30) Foreign Application Priority Data
Nov. 13, 2017 (KR) 10-2017-0150641

(51) Int. Cl. H02J 7/02; H02J 50/10; H02J 50/80; H04B 5/00

(52) U.S. Cl. CPC H02J 7/025; H04B 5/0037; H02J 50/80; H02J 50/10

(57) ABSTRACT

A wireless power transmitter includes: a near field communications (NFC) controller configured to communicate with a wireless power receiver in an NFC method using an NFC coil; and a wireless charging controller configured to wirelessly supply power to the wireless power receiver using a power transmitting coil, and to determine whether a cross connection has occurred for the wireless power receiver by comparing first identification information transmitted to the wireless power receiver in the NFC method with second identification information received from the wireless power receiver in a communications method different from the NFC method.

### CROSS-REFERENCE TO RELATED APPLICATIONS

This application claims benefit under 35 U.S.C. § 119(a) of Korean Patent Application No. 10-2017-0150641 filed on Nov. 13, 2017 in the Korean Intellectual Property Office, the entire disclosure of which is incorporated herein by reference for all purposes.

### BACKGROUND

### 1. Field

The following description relates to a wireless power transmitter.

### 2. Description of Related Art

In accordance with the development of wireless technology, various wireless functions ranging from the transmission of data to the transmission of power may be implemented. A wireless charging technology enabling charging of various types of portable apparatuses in a non-contact manner has become a technology of interest.

In such wireless charging technology, mutual recognition between a wireless power transmitter and a wireless power receiver should be undertaken before performing wireless charging. That is, in a case in which the wireless power receiver is disposed on the wireless power transmitter in a chargeable state, the wireless power transmitter recognizes the wireless power receiver and performs an information exchange for charging.

In a case in which multiple wireless power transmitters are present, mutual recognition between the wireless power transmitter and the wireless power receiver may be erroneously performed.

For example, a situation in which a wireless power receiver disposed on an adjacent wireless power transmitter is recognized and a charging for the recognized wireless power receiver is prepared may occur. Such a situation is known as a cross connection. Due to such a cross connection, the wireless charging may malfunction or efficiency of the wireless charging may decrease.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wireless power transmitter includes: a near field communications (NFC) controller configured to communicate with a wireless power receiver in an NFC method using an NFC coil; and a wireless charging controller configured to wirelessly supply power to the wireless power receiver using a power transmitting coil, and to determine whether a cross connection has occurred for the wireless power receiver by comparing first identification information transmitted to the wireless power receiver in the NFC method with second identification information received from the wireless power receiver in a communications method different from the NFC method.

The wireless charging controller may be further configured to determine that the cross connection has not occurred, in response to the first identification information corresponding to the second identification information.

A communications distance in the NFC method may be shorter than a communications distance in the communications method different from the NFC method.

The wireless power transmitter may further include a wireless communications controller configured to communicate with the wireless power receiver in the communications method different from the NFC method, and to provide the second identification information received from the wireless power receiver to the wireless charging controller.

The communications method different from the NFC method may be a bluetooth method.

The communications method different from the NFC method may be an in-band communications method using a magnetic field formed between a power receiving coil of the wireless power receiver and the power transmitting coil.

The wireless charging controller may be further configured to control the wireless communications controller to transmit a long beacon signal to the wireless power receiver in the communications method different from the NFC method, in response to the wireless charging controller sensing a presence of the wireless power receiver by periodically transmitting a short beacon signal using the power transmitting coil.

The wireless charging controller may be further configured to control the NFC controller to transmit the first identification information to the wireless power receiver in the NFC method.

In another general aspect, a wireless power transmitter includes: a near field communications (NFC) controller configured to communicate with a wireless power receiver in an NFC method using a NFC coil; and a wireless charging controller configured to wirelessly supply power to the wireless power receiver using a power transmitting coil, and to determine whether a cross connection has occurred for the wireless power receiver by comparing first identification information transmitted to the wireless power receiver in a communications method different from the NFC method with second identification information received from the wireless power receiver in the NFC method.

The wireless charging controller may be further configured to determine that the cross connection has not occurred, in response to the first identification information corresponding to the second identification information.

A communications distance in the NFC method may be shorter than a communications distance in the communications method different from the NFC method.

The wireless power transmitter may further include a wireless communications controller configured to communicate with the wireless power receiver in the communications method different from the NFC method, and to transmit the second identification information to the wireless power receiver in the communications method different from the NFC method.

The communications method different from the NFC method may be a bluetooth method.

The communications method different from the NFC method is an in-band communications method using a magnetic field formed between a power receiving coil of the wireless power receiver and the power transmitting coil.

The wireless charging controller may be further configured to control the wireless communications controller to transmit a long beacon signal to the wireless power receiver in the communications method different from the NFC method, in response to the wireless charging controller sensing a presence of the wireless power receiver by periodically transmitting a short beacon signal using the power transmitting coil.

The wireless charging controller may be further configured to control the NFC controller to communicate with the wireless power receiver and receive the second identification information, in response to the long beacon signal being transmitted.

Other features and aspects will be apparent from the following detailed description, the drawings, and the claims.

### BRIEF DESCRIPTION OF DRAWINGS

FIG. 1 is a diagram illustrating a cross connection which may occur in an environment in which multiple wireless power transmitters are present.

FIG. 2 is a diagram illustrating respective phases of wireless power transmission.

FIG. 3 is a block diagram illustrating an example of a wireless power transmitter.

FIG. 4 is a block diagram illustrating another example of a wireless power transmitter.

FIG. 5 is a block diagram illustrating an example of a wireless power receiver.

FIG. 6 is a block diagram illustrating another example of a wireless power receiver.

FIG. 7 is a diagram of an example of a method for confirming a cross connection.

FIG. 8 is a diagram of another example of a method for confirming a cross connection.

FIG. 9 is a diagram of another example of a method for confirming a cross connection.

FIG. 10 is a diagram of another example of a method for confirming a cross connection.

FIGS. 11A and 11B are diagrams illustrating signal transmission in an example of a method for confirming a cross connection.

FIG. 12 is a flowchart illustrating an example of a method for providing wireless charging.

FIG. 13 is a flowchart illustrating another example of a method for providing wireless charging.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

The features of the examples described herein may be combined in various ways as will be apparent after an understanding of the disclosure of this application. Further, although the examples described herein have a variety of configurations, other configurations are possible as will be apparent after an understanding of the disclosure of this application.

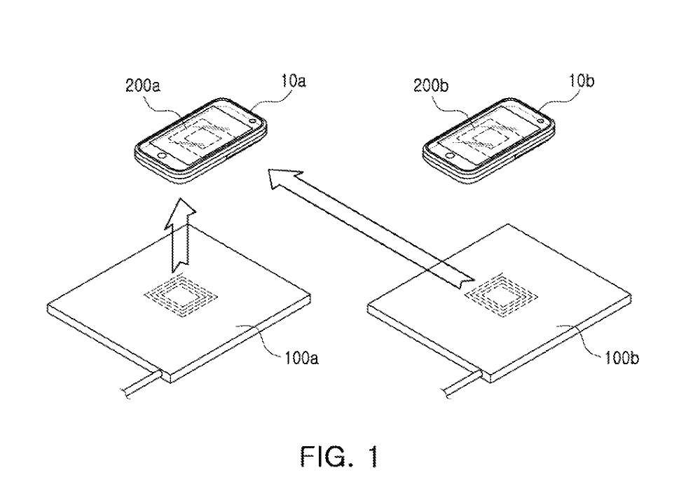

FIG. 1 is a diagram illustrating a cross connection which may occur in an environment to which multiple wireless power transmitters are applied.

Referring to FIG. 1, first and second wireless power transmitters 100a and 100b may be connected to an external power source to wirelessly supply power to first and second wireless power receivers 200a and 200b. The first and second wireless power receivers 200a and 200b may provide the wirelessly supplied power to first and second mobile terminals 10a and 10b, respectively.

In an environment in which the wireless power transmitters 100a and 100b are present and the wireless power receivers 200a and 200b or one of the wireless power receivers 200a or 200b is present, a cross connection may occur.

In the scenario illustrated in FIG. 1, the cross connection is an erroneous connection between the wireless power transmitter 100b and the wireless power receiver 200a.

For example, in a case in which the first wireless power receiver 200a is adjacent to the first and second wireless power transmitters 100a and 100b, the first and second wireless power transmitters 100a and 100b may each recognize the first wireless power receiver 200a, and a mutual connection for wireless power charging, that is, communications, may occur.

In this case, as illustrated, a connection between the second wireless power transmitter 100b, which is not an actual charging target, and the first wireless power receiver 200a is referred to as the cross connection.

If such a cross connection has occurred, the second wireless power transmitter 100b may perform a standby operation until the wireless power receiver 200a is reset. As a result, even in a case in which the second wireless power receiver 200b, which is the actual charging target, is adjacent to the second wireless power transmitter 100b, a problem in that the second wireless power transmitter 100b does not provide wireless charging may occur.

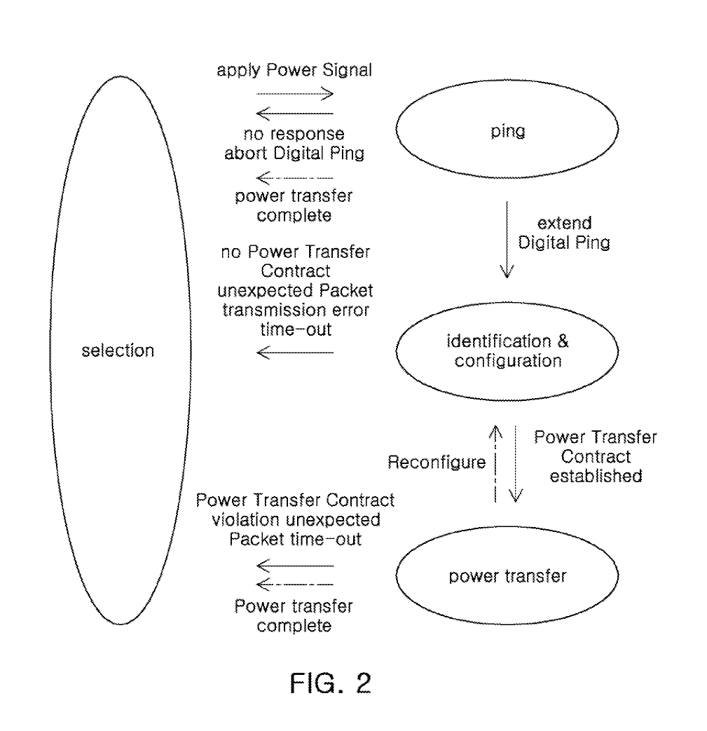

FIG. 2 is a diagram illustrating the respective phases of wireless power transmission. Hereinafter, a description will be made based on a Qi standard developed by the wireless power consortium (WPC) using electromagnetic induction. However, this description is merely illustrative. Therefore, it is apparent that an airfuel inductive (AFI) standard selected by airfuel alliance (AFA) or an airfuel resonant (AFR) standard using magnetic resonance may be applied.

Referring to FIG. 2, in order to wirelessly transmit the power, a selection phase may be initially performed.

In the selection phase, the wireless power transmitter may transmit an analog ping signal, and determine whether or not an object is positioned in a vicinity of the wireless power transmitter based on whether a change in the analog ping signal, for example, a change in impedance or other changes, occurs.

Since the terminology “analog ping signal” collectively refers to a signal for detecting an external object, it is not limited to an analog ping signal. For example, a signal used in different expressions according to standards or embodiments, for example, a short beacon signal or the like, may correspond to the analog ping signal as long as the signal determines whether a specific object is positioned around the wireless power transmitter.

In the selection phase, if it is determined that the external object is positioned adjacent to the wireless power transmitter using the analog ping signal, the wireless power transmitter may confirm whether the adjacent external object is the wireless power receiver. That is, the wireless power transmitter may transmit a digital ping signal, and may determine whether the adjacent object is the wireless power receiver based on whether a response signal for the digital ping signal is received from the wireless power receiver. The phase including the transmission of the digital ping signal and the determination of whether the response signal for the digital ping signal is received from the wireless power receiver is referred to as a ping phase.

Here, the digital ping signal collectively refers to as a signal for wireless communications with the wireless power receiver, and may correspond to various signals, for example, a long beacon signal, and the like, performing wireless communications.

If the response signal of the wireless power receiver for the digital ping signal is received by the wireless power transmitter, the wireless power transmitter may transmit the response signal to the wireless power receiver to confirm requirement information for wireless charging, such as a target of wireless charging, a power requirement, or the like. The phase including the receipt of the response signal of the wireless power receiver for the digital ping signal and the transmission of the response signal to the wireless power receiver to confirm the requirement information for the wireless charging is referred to as an identification & configuration phase.

Thereafter, the wireless power transmitter may wirelessly transfer power to the wireless power receiver according to the confirmed requirement information. This is referred to a power transfer phase.

Since the digital ping signal is transmitted through short-range wireless communications such as Bluetooth® or the like, a cross connection with the adjacent wireless power receiver which is not the target of wireless charging may be caused, as described above.

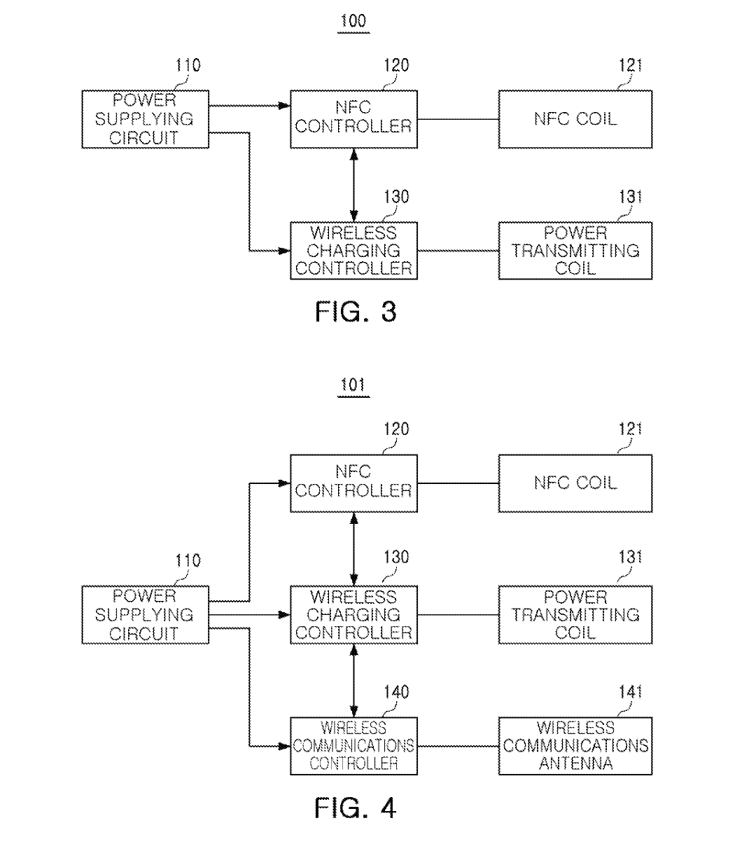

Therefore, according to an embodiment disclosed herein, such a cross connection may be prevented by using a near field communications (NFC) method. Hereinafter, various embodiments will be described with reference to FIGS. 3 through 13.

FIG. 3 is a block diagram illustrating an example of a wireless power transmitter 100. Referring to FIG. 3, the wireless power transmitter 100 may include a power supplying circuit 110, a near field communications (NFC) controller 120, and a wireless charging controller 130.

The power supplying unit 110 may supply power to other components within the wireless power transmitter 100. As an example, the power supplying circuit 110 may include a direct current (DC)—DC converter that receives a DC voltage and converts the DC voltage into a voltage required by each of the components to provide the required voltage to each of the components.

The NFC controller 120 may communicate with the wireless power receiver 200 using the NFC method using a near field communications (NFC) coil 121. To this end, the wireless power receiver 200 may also include an NFC coil and an NFC controller.

According to an embodiment, the NFC controller 120 may operate as an NFC reader and the wireless power receiver 200 may operate as an NFC tag. Therefore, the NFC controller 120 may transmit a power signal including identification information including a preset or specified identifier to the wireless power receiver 200 using the NFC coil 121, and the NFC controller in the wireless power receiver 200 may receive the power signal and may confirm the identification information included in the power signal.

As described above, the NFC controller 120 may determine whether the cross connection has occurred by comparing the transmitted or received identification information with each other. This is because when wireless communications are performed by the NFC method, a communications distance is only a few centimeters, such that the cross connection may not substantially occur. That is, the NFC controller 120 may transmit or receive first identification information using the NFC method and transmit or receive second identification information using another communications method, and may then determine whether the cross connection has occurred depending on whether the first identification information and the second identification information include the same identifier.

Hereinafter, a detailed description will be provided with reference to FIG. 3.

The wireless charging controller 130 may wirelessly supply the power to the wireless power receiver using a power transmitting coil 131.

The wireless charging controller 130 may be magnetically coupled to the wireless power receiver 200 in various methods. That is, in the present specification, the wireless charging controller 130 is not limited to a particular standard or a particular method. For example, the wireless charging controller 130 may use a magnetic resonance method or may also use a magnetic induction method. As another example, the wireless charging controller 130 may use at least one of various methods such as a WPC method, an A4WP method, and the like, or various standards.

The wireless charging controller 130 may determine whether the cross connection has occurred for the wireless power receiver by comparing the first identification information transmitted to the wireless power receiver 200 by the NFC method and the second identification information received from the wireless power receiver 200 by a communications method different from the NFC method.

If the first identification information corresponds to the second identification information, the wireless charging controller 130 may determine that the cross connection has not occurred. Meanwhile, if the first identification information does not correspond to the second identification information, the wireless charging controller 130 may determine that the cross connection has occurred.

In this example, the communications method different from the NFC method may be, for example, an in-band communications method in which information is transmitted using the magnetic field formed for wireless charging.

That is, the wireless power receiver 200 may receive the first identification information from the wireless power transmitter 100 in the NFC method. The wireless power receiver 200 may generate the second identification information having the same identifier as the first identification information, in other words, corresponding to the first identification information, and may provide the generated second identification information to the wireless power transmitter in the communications method different from the NFC. The wireless power transmitter may determine whether the cross connection has occurred by comparing the second identification information received by the communications method different from the NFC and the first identification information transmitted by the NFC method with each other.

As a result, according to an embodiment, it may be determined whether the wireless charging is performed for the same target by transmitting or receiving identification information having the same identification characteristics using the NFC method and a second communications method different from the NFC method.

According to the disclosure herein, a communications distance in the NFC method may be shorter than the communications distance in the communications method different from the NFC method. That is, since the NFC method has an identification distance of only a few centimeters or is set so that the identification distance is only a few centimeters, the cross connection itself may not occur in the NFC method. On the other hand, in the case of a communications method such as Bluetooth®, since the identification distance is a few meters, the cross connection may be caused. Therefore, the cross connection may be thoroughly prevented by using the NFC method as one communications method for transmitting and receiving the identification information.

FIG. 4 is a block diagram illustrating another example of a wireless power transmitter 101.

Referring to FIG. 4, the wireless power transmitter 101 may further include a wireless communications controller 140, in addition to the other components included in the example illustrated in FIG. 3.

The wireless communications controller 140 may communicate with a wireless power receiver 201 (FIG. 6) by a second wireless communications method different from the NFC method using a wireless communications antenna 141.

As an example, the wireless communications controller 140 may be a Bluetooth® module that communicates with the wireless power receiver in a Bluetooth® method.

As an example, the wireless communications controller 140 may receive the second identification information from the wireless power receiver 201 in the second wireless communications method and provide the second identification information to the wireless charging controller 130.

Alternatively, as another example, the wireless communication controller 140 may transmit the first identification information to the wireless power receiver 201 in the second wireless communications method according to a control of the wireless charging controller 130.

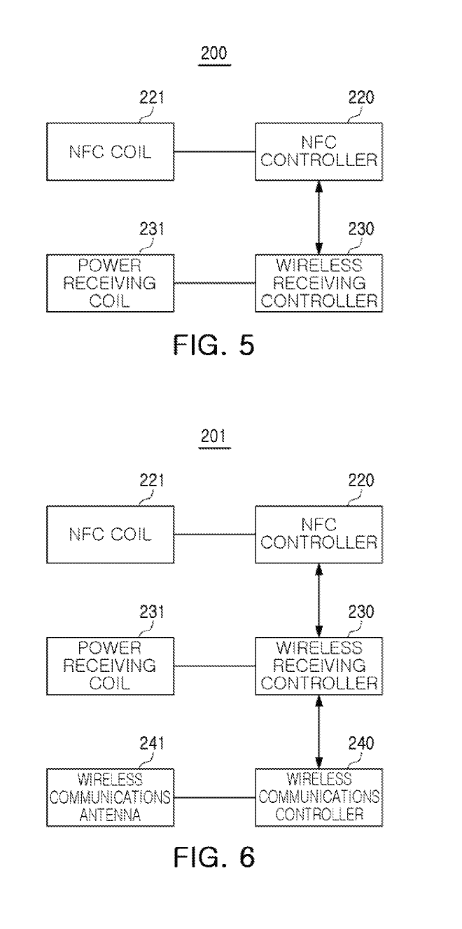

FIG. 5 is a block diagram illustrating an example of the wireless power receiver 200.

The wireless power receiver 200 according to the example illustrated in FIG. 5 is operable by interworking with the wireless power transmitter 100 illustrated in FIG. 3. Referring to FIG. 5, the wireless power receiver 200 may include an NFC controller 220 and a wireless receiving controller 230.

The NFC controller 220 may communicate with the NFC controller 120 of the wireless power transmitter 100 in the NFC method using an NFC coil 221.

The wireless receiving controller 230 may wirelessly receive power from the wireless power transmitter 100 using a power receiving coil 231. That is, the power receiving coil 231 of the wireless power receiver may be magnetically coupled to the power transmitting coil 131 of the wireless power transmitter 100 to receive energy converted to an alternating current, thereby receiving the power.

FIG. 6 is a block diagram illustrating the wireless power receiver 201, according to an example. The wireless power receiver 201 according to the example illustrated in FIG. 6 is operable by interworking with the wireless power transmitter 101 illustrated in FIG. 4.

Referring to FIG. 6, the wireless power receiver 201 may further include a wireless communications controller 240 in the example illustrated in FIG. 5.

The wireless communications controller 240 may wirelessly communicate with the wireless communications controller 140 of the wireless power transmitter 101 through a wireless communications antenna 241. As an example, the wireless communications controller 240 may be a Bluetooth® module that communicates with the wireless power transmitter 101 in a Bluetooth® method.

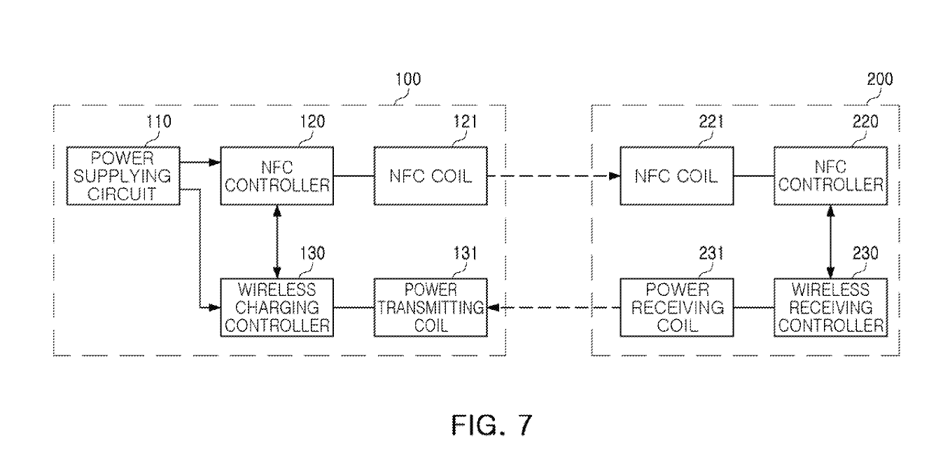

Hereinafter, various examples of a method for determining whether a cross connection has occurred will be described with reference to FIGS. 7 through 10.

FIG. 7 is a diagram of an example of a method for determining whether a cross connection has occurred. FIG. 7 relates to an example of providing first identification information in an NFC method and receiving second identification information in an in-band method.

Referring to FIG. 7, the wireless power transmitter 100 may provide the first identification information to the wireless power receiver 200 in the NFC method. As an example, the wireless charging controller 130 may provide identifier information to the NFC controller 120, and the NFC controller 120 may provide the first identification information including the identifier information to the wireless power receiver 200 in the NFC method.

If the NFC controller 220 included in the wireless power receiver 200 receives the first identification information, the NFC controller 220 may provide the first identification information to the wireless receiving controller 230. The wireless receiving controller 230 may confirm the first identification information and generate second identification information corresponding to the first identification information. According to an embodiment, the wireless receiving controller 230 may also use the received first identification information as the second identification information as it is.

The wireless receiving controller 230 may transmit the generated second identification information to the wireless power transmitter 100 in the in-band method using a magnetic coupling between the power receiving coil 231 and the power transmitting coil 131. For example, the wireless receiving controller 230 may provide the second identification information in the in-band communications method by performing a modulation so that a signal corresponding to the second identification information is carried in a magnetic field formed between the power receiving coil 231 and the power transmitting coil 131.

The wireless charging controller 130, upon receiving the second identification information, may determine whether the cross connection has occurred by comparing the second identification information with the first identification information as described above.

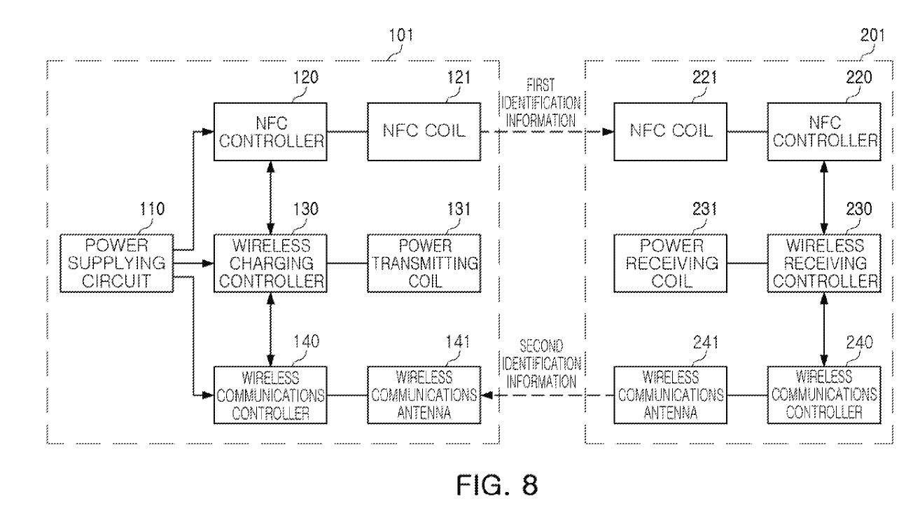

FIG. 8 is a diagram of another example of a method for determining whether a cross connection has occurred. FIG. 8 relates to an example of providing the first identification information in the NFC method and receiving the second identification information in the second wireless communications method, for example, a Bluetooth® method.

Referring to FIG. 8, the wireless power transmitter 101 may provide the first identification information to the wireless power receiver 201 in the NFC method, and the wireless receiving controller 230 may generate the second identification information corresponding to the first identification information, as described above.

The wireless receiving controller 230 may control the wireless communications controller 240 to provide the second identification information to the wireless power transmitter 101.

If the wireless communications controller 140 of the wireless power transmitter 101 receives the second identification information, the wireless communications controller 140 may provide the second identification information to the wireless charging controller 130. The wireless charging controller 130 receiving the second identification information may determine whether the cross connection has occurred by comparing the second identification information with the first identification information.

The examples described with reference to FIGS. 7 and 8 are described above based on the first identification information being transmitted using the NFC method. However, various modifications of the transmission of the first identification information in the examples of FIGS. 7 and 8 are possible.

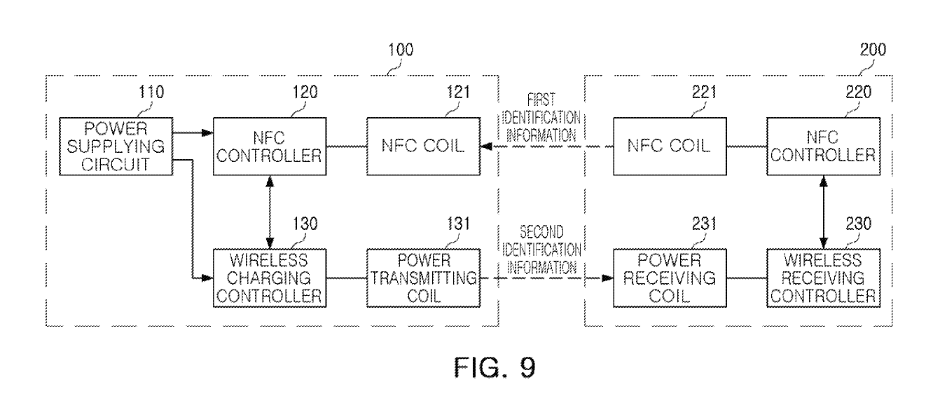

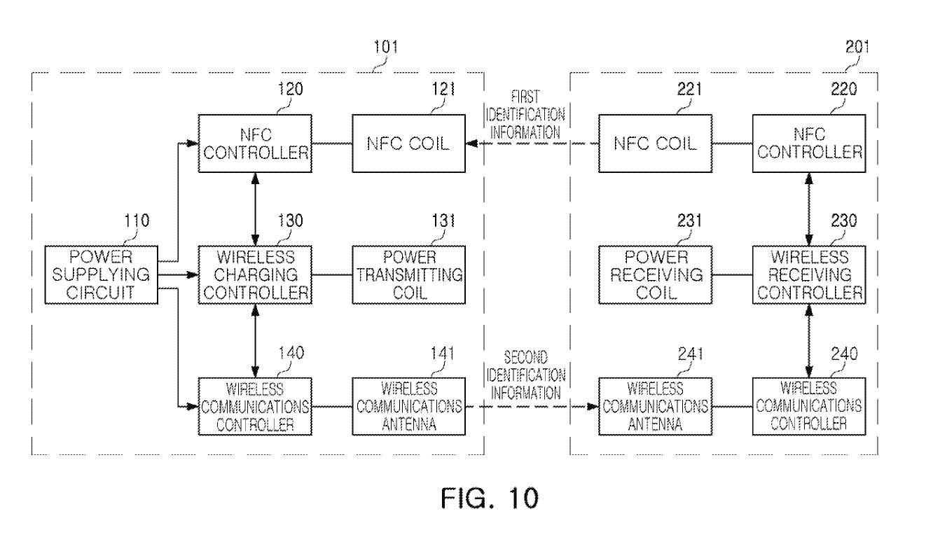

In modified examples, the identification information may be received by the wireless power transmitter using the NFC method. Such examples will be described with reference to FIGS. 9 and 10.

FIG. 9 is a diagram of another example of a method for determining whether a cross connection has occurred. FIG. 9 relates to an example of providing the first identification information in the in-band method and receiving the second identification information the NFC method.

Referring to FIG. 9, the wireless power transmitter 100 may provide the first identification information to the wireless power receiver 200 in the in-band method by using the magnetic field formed between the power transmitting coil 131 and the power receiving coil 231.

The wireless receiving controller 230, upon receiving the first identification information, may generate the second identification information corresponding to the first identification information.

The wireless receiving controller 230 may control the NFC controller 220 to provide the second identification information to the wireless power transmitter 100 in the NFC method.

If the NFC controller 120 of the wireless power transmitter 100 receives the second identification information, the NFC controller 120 may provide the second identification information to the wireless charging controller 130. The wireless charging controller 130, upon receiving the second identification information, may determine whether the cross connection has occurred by comparing the second identification information with the first identification information.

FIG. 10 is a diagram of another example of a method for confirming a cross connection. FIG. 10 relates to an example of providing the first identification information in the second wireless communications method, for example, the Bluetooth® method and receiving the second identification information in the NFC method.

Referring to FIG. 10, the wireless charging controller 130 of the wireless power transmitter 101 may provide the first identification information to the wireless power receiver 201 through the wireless communications antenna 141 by interworking with the wireless communications controller 140.

The wireless receiving controller 230, upon receiving the first identification information, may generate the second identification information corresponding to the first identification information.

The wireless receiving controller 230 may control the NFC controller 220 to provide the second identification information to the wireless power transmitter 101 in the NFC method.

If the NFC controller 120 of the wireless power transmitter 100 receives the second identification information, the NFC controller 120 may provide the second identification information to the wireless charging controller 130. The wireless charging controller 130, upon receiving the second identification information, may determine whether the cross connection has occurred by comparing the second identification information with the first identification information.

The above description is based on the example in which it is determined whether the cross connection has occurred by comparing the first identification information and the second identification information with each other in the wireless power transmitter 100/101. However, according to an embodiment, the wireless power receiver 200/201 may also determine whether the cross connection has occurred. For example, the wireless power receiver 200/201 may determine whether the cross connection has occurred and may then provide a result of the determination to the wireless power transmitter 100/101. As described above, various modified examples are possible.

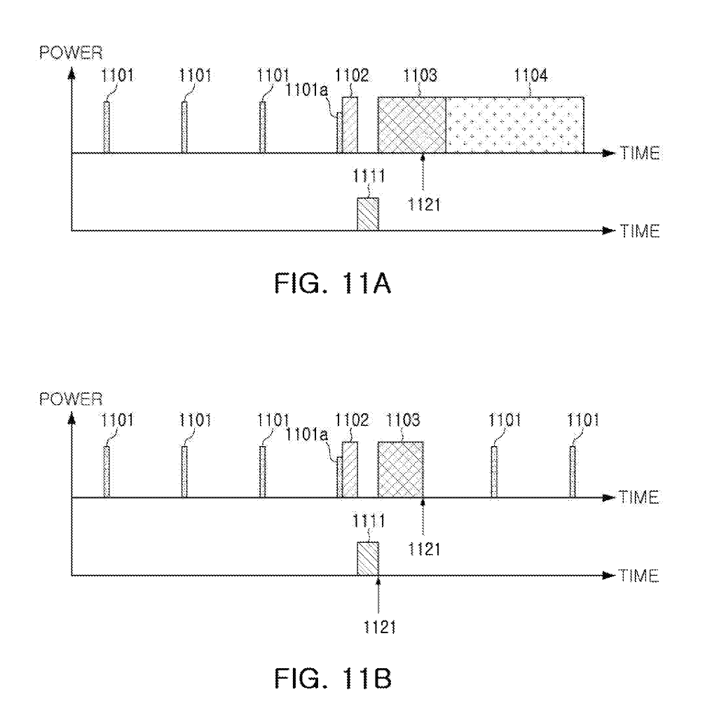

FIGS. 11A and 11B are diagrams illustrating signal transmission in an example method for determining whether a cross connection has occurred. FIGS. 11A and 11B relate to examples using the NFC method and the in-band communications method.

Referring to FIG. 11A, the wireless charging controller 130 of the wireless power transmitter 101 may periodically transmit a short beacon signal 1101 using the power transmitting coil 131.

If an external object exists around the wireless power transmitter 101, a short beacon signal 1101a having changed impedance may be caused. Therefore, the wireless power transmitter 101 may sense an existence of the external object, for example, the wireless power receiver 201 by sensing the short beacon signal 1101a having the changed impedance.

The wireless power transmitter 101 may transmit a long beacon signal 1102 to determine whether the external object is the wireless power receiver 201. The long beacon signal may be transmitted in the second wireless communications method, for example, Bluetooth® or the like, by the wireless communications controller 140.

The wireless power transmitter 101 may control the NFC controller 120 to transmit the first identification information to the wireless power receiver 201 in the NFC method after transmitting the long beacon signal 1102.

Thereafter, the wireless power transmitter 101 may receive (1121) the second identification information from the wireless power receiver 200 in the in-band communications method using the magnetic field formed between the wireless power transmitter 100 and the wireless power receiver 200.

If the first identification information and the second identification information are the same as each other, the wireless power transmitter 101 may determine that the cross connection has not occurred and continue to perform a preparation procedure for wireless power transmission (1103). Thereafter, the wireless power transmitter 100 may wirelessly transmit the power to the wireless power receiver (1104).

Referring to FIG. 11B, the wireless charging controller 130 of the wireless power transmitter 101 may periodically transmit a short beacon signal 1101 using the power transmitting coil 131.

If an external object exists in the vicinity of the wireless power transmitter 101, a short beacon signal 1101a having changed impedance may be caused. Therefore, the wireless power transmitter 100 may sense an existence of the external object, for example, the wireless power receiver 200 by sensing the short beacon signal 1101a having the changed impedance.

The wireless power transmitter 101 may transmit a long beacon signal 1102 to determine whether the external object is the wireless power receiver 200. The long beacon signal may be transmitted in the second wireless communications method, for example, Bluetooth® or the like, by the wireless communications controller 140.

The wireless power transmitter 101 may control the NFC controller 120 to transmit the first identification information 1111 to the wireless power receiver 200 in the NFC method after transmitting the long beacon signal 1102.

Thereafter, the wireless power transmitter 101 may receive (1121) the second identification information from the wireless power receiver 200 in the in-band communications method using the magnetic field formed between the wireless power transmitter 100 and the wireless power receiver 200.

If the first identification information and the second identification information are different from each other, the wireless power transmitter 101 may determine that the cross connection has occurred (1121) and stop the preparation procedure for wireless power transmission. Thereafter, the wireless power transmitter 101 may periodically transmit the short beacon signal 1101 by again using the power transmitting coil 131.

The FIGS. 11A and 11B described above relate to examples in which the communications are performed in the NFC method after the long beacon signal is transmitted, that is, before the ping phase ends and the identification & configuration phase starts. That is, FIGS. 11A and 11B relate to the example in which the second identification information is received in the in-band communications method in the identification & configuration phase.

However, the examples of FIGS. 11A and 11B are merely illustrative, and various modified examples are possible. For example, the NFC communications may be performed after the identification & configuration phase or may be performed at the same time as the ping phase or the identification and & configuration phase.

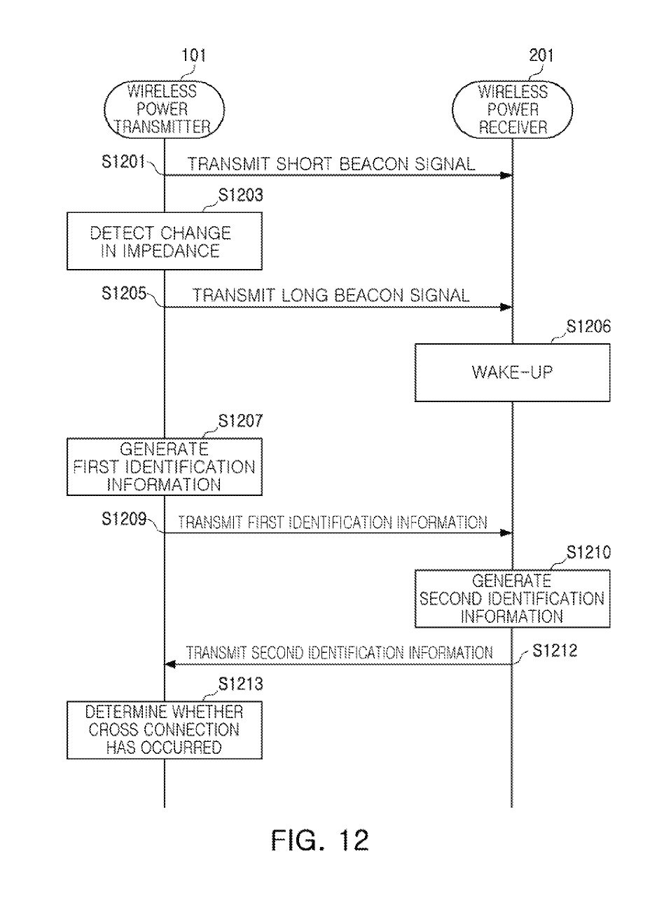

FIG. 12 is a flowchart illustrating an example of a method for providing wireless charging.

The example illustrated in FIG. 12 relates to an example in which the wireless power transmitter determines whether the cross connection has occurred.

Referring to FIG. 12, the wireless power transmitter 101 may periodically transmit a short beacon signal in operation S1201, and may transmit a long beacon signal in operation S1205 when a change in impedance of the short beacon signal is detected in operation S1203.

If the wireless power receiver 201 receives the long beacon signal, the wireless power receiver 201 may be woken-up in operation S1206. For example, if the long beacon signal is received in the second communications method, the wireless communications controller 240 may be woken-up using power by the long beacon signal, and the woken-up wireless communications controller 240 may wake-up the wireless power receiver 201.

The NFC controller 120 may generate the first identification information in operation S1207, and the wireless power transmitter 101 may transmit the first identification information in the NFC method in operation S1209. The wireless power receiver 201, upon receiving the first identification information, may generate the second identification information corresponding to the first identification information in operation S1210, and transmit the second identification information to the wireless power transmitter 101 in a method different from the NFC method in operation S1212.

The wireless power transmitter 101, upon receiving the second identification information, may determine whether the cross connection has occurred by comparing the second identification information with the first identification information in operation S1213.

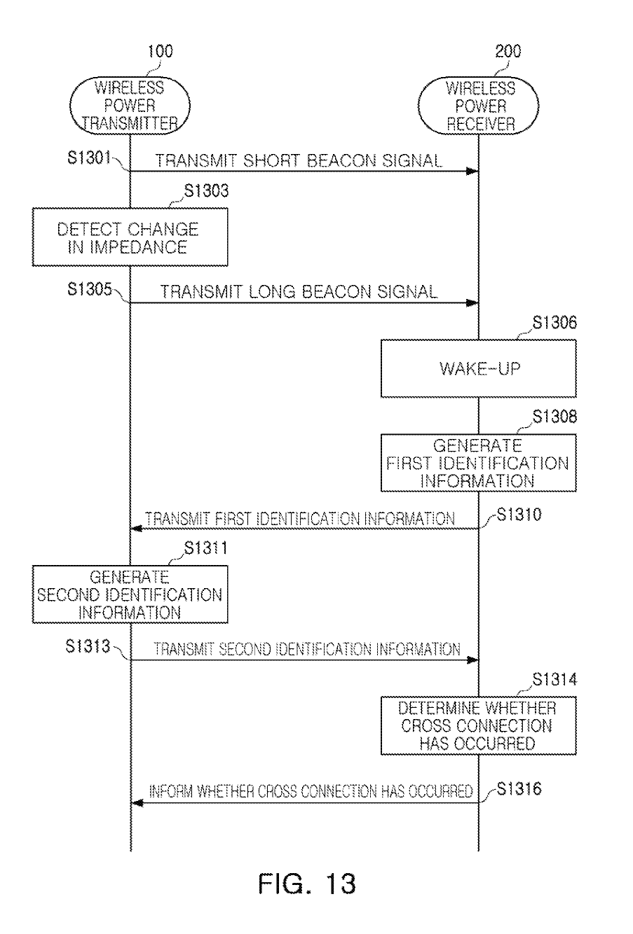

FIG. 13 is a flowchart illustrating another example of a method for providing wireless charging.

The example illustrated in FIG. 13 relates to an example in which the wireless power receiver determines whether the cross connection has occurred.

Referring to FIG. 13, the wireless power transmitter 100 may periodically transmit a short beacon signal in operation S1301, and may transmit a long beacon signal in operation S1305 when a change in impedance of the short beacon signal is detected in operation S1303.

If the wireless power receiver 200 receives the long beacon signal, the wireless power receiver 200 may be woken-up in operation S1306.

The woken-up wireless power receiver 200 may generate the first identification information in operation S1308, and may transmit the first identification information to the wireless power transmitter 100 in another method other than the NFC method, for example, a short-range wireless communications method such as Bluetooth® or the like, or an in-band method using a magnetic field, or the like, in operation S1310.

The wireless power transmitter 100, upon receiving the first identification information, may generate the second identification information corresponding to the first identification information in operation S1311 and may transmit the second identification information to the wireless power receiver 200 in the NFC method in operation S1313.

The wireless power receiver 200, upon receiving the second identification information, may determine whether t the cross connection has occurred by comparing the second identification information with the first identification information in operation S1314. The wireless power receiver 200 may inform the wireless power transmitter 100 of whether the cross connection has occurred in operation S1316.

As set forth above, according to the embodiments disclosed herein, a wireless power transmitter may increase an accuracy of wireless charging by accurately determining whether a cross connection has occurred during the wireless charging.

The NFC controller 120 and the wireless charging controller 130 of FIGS. 3, 4, and 7-10, the wireless communications controller 140 of FIGS. 4, 8, and 10, the NFC controller 220 and the wireless receiving controller 230 of FIGS. 5-10, and the wireless communication controller of FIGS. 6, 8, and 10 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2, 7-10, 11A, 11B, 12, and 13 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power transmitter, comprising:
a near field communications (NFC) controller configured to communicate with a wireless power receiver in an NFC method using an NFC coil; and
a wireless charging controller configured to wirelessly supply power to the wireless power receiver using a power transmitting coil, and to determine whether a cross connection has occurred for the wireless power receiver by comparing first identification information transmitted to the wireless power receiver in the NFC method with second identification information received from the wireless power receiver in a communications method different from the NFC method.

2. The wireless power transmitter of claim 1, wherein the wireless charging controller is further configured to determine that the cross connection has not occurred, in response to the first identification information corresponding to the second identification information.

3. The wireless power transmitter of claim 1, wherein a communications distance in the NFC method is shorter than a communications distance in the communications method different from the NFC method.

4. The wireless power transmitter of claim 1, further comprising a wireless communications controller configured to communicate with the wireless power receiver in the communications method different from the NFC method, and to provide the second identification information received from the wireless power receiver to the wireless charging controller.

5. The wireless power transmitter of claim 4, wherein the communications method different from the NFC method is a bluetooth method.

6. The wireless power transmitter of claim 1, wherein the communications method different from the NFC method is an in-band communications method using a magnetic field formed between a power receiving coil of the wireless power receiver and the power transmitting coil.

7. The wireless power transmitter of claim 4, wherein the wireless charging controller is further configured to control the wireless communications controller to transmit a long beacon signal to the wireless power receiver in the communications method different from the NFC method, in response to the wireless charging controller sensing a presence of the wireless power receiver by periodically transmitting a short beacon signal using the power transmitting coil.

8. The wireless power transmitter of claim 7, wherein the wireless charging controller is further configured to control the NFC controller to transmit the first identification information to the wireless power receiver in the NFC method.

9. A wireless power transmitter, comprising:
a near field communications (NFC) controller configured to communicate with a wireless power receiver in an NFC method using a NFC coil; and
a wireless charging controller configured to wirelessly supply power to the wireless power receiver using a power transmitting coil, and to determine whether a cross connection has occurred for the wireless power receiver by comparing first identification information transmitted to the wireless power receiver in a communications method different from the NFC method with second identification information received from the wireless power receiver in the NFC method.

10. The wireless power transmitter of claim 9, wherein the wireless charging controller is further configured to determine that the cross connection has not occurred, in response to the first identification information corresponding to the second identification information.

11. The wireless power transmitter of claim 9, wherein a communications distance in the NFC method is shorter than a communications distance in the communications method different from the NFC method.

12. The wireless power transmitter of claim 9, further comprising a wireless communications controller configured to communicate with the wireless power receiver in the communications method different from the NFC method, and to transmit the second identification information to the wireless power receiver in the communications method different from the NFC method.

13. The wireless power transmitter of claim 12, wherein the communications method different from the NFC method is a bluetooth method.

14. The wireless power transmitter of claim 9, wherein the communications method different from the NFC method is an in-band communications method using a magnetic field formed between a power receiving coil of the wireless power receiver and the power transmitting coil.

15. The wireless power transmitter of claim 12, wherein the wireless charging controller is further configured to control the wireless communications controller to transmit a long beacon signal to the wireless power receiver in the communications method different from the NFC method, in response to the wireless charging controller sensing a presence of the wireless power receiver by periodically transmitting a short beacon signal using the power transmitting coil.

16. The wireless power transmitter of claim 15, wherein the wireless charging controller is further configured to control the NFC controller to communicate with the wireless power receiver and receive the second identification information, in response to the long beacon signal being transmitted.
